(19) United States
(12) Patent Application Publication
(10) Pub. No.: US 2026/0127392 A1
(43) Pub. Date: May 7, 2026

(54) MULTI-STAGE MACHINE LEARNING AUTOMATED CODING PIPELINE

(71) Applicant: Optum, Inc., Minnetonka, MN (US)

(72) Inventors: Zahra Mahmoodzadeh POORNAKI, Laguna Niguel, CA (US); Fazlolah MOHAGHEGH, Frisco, TX (US); Jagadish VENKATARAMAN, Menlo Park, CA (US); Hamid Reza HASSANZADEH, Suwanee, GA (US); Shannon BUTKUS, College Station, TX (US); Michele R. O'CONNELL, Beacon Falls, CT (US); Teresa I. ANTHONY, Tampa, FL (US); Jag KANCHIRAKKOL, Frisco, TX (US); Jennifer A. GARVAS, Willoughby, OH (US); Jennifer M. LATHROP, Hooksett, NH (US)

(21) Appl. No.: 18/934,651

(22) Filed: Nov. 1, 2024

(51) Int. Cl. G06F 40/58

(52) U.S. Cl. CPC G06F 40/58

(57) ABSTRACT

Various embodiments of the present disclosure provide machine learning architectures for improving predictive functionality of a computer. The techniques apply a multi-stage machine learning automated coding pipeline to a coding domain to generate a code prediction for a text segment. During a first stage, the techniques may include inputting a text segment from a file to a machine learning encoder to generate a text segment vector and extracting a subset of searching codes from a vector data store based on a comparison between the text segment vector and a plurality of code vectors within the vector data store. During a second stage, the techniques may include generating a generative model prompt based on the subset of searching codes and inputting the generative model prompt to a generative model to generate a code prediction for the text segment.

### BACKGROUND

Various embodiments of the present disclosure address technical challenges related to machine learning technology, including the application of machine learning in automated coding processes. In various domains, standardized codes (e.g., a sequence of characters, numerals) may be used to designate an actionable insight with respect to an entity. Such codes are traditionally used to improve computer understanding by translating natural language text to a recognizable code. The efficacy of codes within a particular domain is limited by a computer's capability of translating natural language text to a recognizable code. This task is hindered by several technical challenges presented by codes that (i) are adapted over time, (ii) defined by multiple different parties, or (iii) correlate to a plurality of variations of natural language text.

Traditionally, these technical challenges are addressed by using tables that statically translate natural language text to an associated code. These tables include lists of codes for each natural language term or phrase encountered by the developer of the table. While helpful for codes with minimal variations of natural language text, the processing resources and time expense of maintaining static lists is prohibitive for codes that are associated with highly individualized variations of natural language text. This leads to diverging coding tables, rather than a universal table, that are individually maintained by participates of a coding domain. Each of the diverging coding tables are limited to a portion of a universal code space and may include mappings that diverge from one another. This leads to inconsistent parsing of natural language text that negatively impacts the accuracy and reliability of downstream processes. Moreover, when codes are modified, diverging coding tables may require individualized modifications that require a prohibitive amount of computing resources and still further separate the similarities between the tables.

Various embodiments of the present disclosure make important contributions to traditional coding technologies by addressing these technical challenges, among others.

### BRIEF SUMMARY

Various embodiments of the present disclosure provide machine learning model architectures and pipelines that improve the functionality of a computer through machine learning processes that address the technical challenges discussed herein. To do so, some embodiments of the present disclosure present a multi-stage machine learning automated coding pipeline that streamlines and optimizes the translation of natural language text segments to codes defined within a coding domain. The multi-staged technique leverages embedding technologies to generate semantic representations that may be used to implement a first relevancy filter to extract a short-listed set of codes for consideration by subsequent stages of the multi-staged technique. By doing so, the multi-staged technique reduces a prediction scope of an autonomous coding process to a size that is manageable by model architectures that traditionally underperform in autonomous coding processes. This allows the use of new model architectures, such a question-answering (Q/A) large language model (LLM), within an autonomous coding pipeline, among other technical advantages as described herein.

In some embodiments, the techniques (e.g., hardware, software, machine-learned model(s), computer-implemented method(s), system(s), and/or one or more non-transitory computer-readable media) may comprise inputting, by one or more processors, a text segment from a file, such as a natural language document, to a machine learning encoder to generate a text segment vector; extracting, by the one or more processors, a subset of searching codes from a vector data store based on a comparison between the text segment vector and a plurality of code vectors within the vector data store; generating, by the one or more processors, a generative model prompt based on the subset of searching codes; and inputting, by the one or more processors, the generative model prompt to a generative model to generate a code prediction for the text segment.

### BRIEF DESCRIPTION OF THE DRAWINGS

FIG. 1 depicts an example overview of an architecture in accordance with some embodiments of the present disclosure.

FIG. 2 depicts an example predictive data analysis computing entity in accordance with some embodiments of the present disclosure.

FIG. 3 depicts an example client computing entity in accordance with some embodiments of the present disclosure.

FIG. 4 depicts a dataflow diagram of a multi-layered autonomous coding framework in accordance with some embodiments of the present disclosure.

FIGS. 5A-B depicts operational examples of a code request in accordance with some embodiments of the present disclosure.

FIG. 6 depicts a flowchart diagram of an example process for implementing a multi-layered autonomous coding framework in accordance with some embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. OVERVIEW OF EMBODIMENTS

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

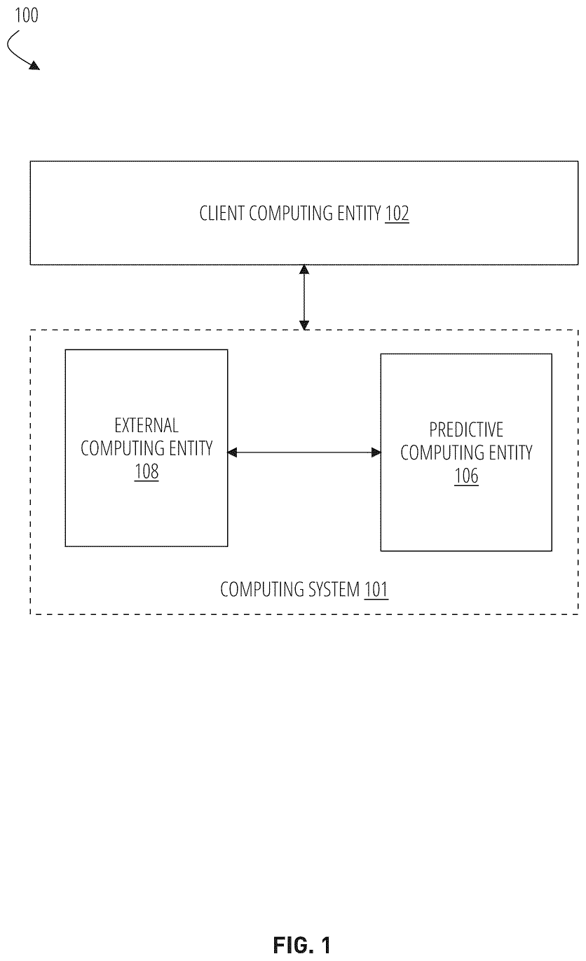

FIG. 1 provides an example overview of an architecture 100 in accordance with some embodiments of the present disclosure. The architecture 100 includes a computing system 101 configured to receive requests, such as code requests, from client computing entities 102, process the requests to generate code predictions, and provide the code predictions to the client computing entities 102. The example architecture 100 may be used in a plurality of domains and not limited to any specific application as disclosed herewith. The plurality of domains may include healthcare, industrial, manufacturing, computer security, and/or the like to name a few.

In accordance with various embodiments of the present disclosure, one or more machine learning models may be trained to generate code prediction, and/or one or more intermediary outputs (e.g., searching codes). The models may form a machine learning pipeline that may be configured to autonomously code a text segment with respect to a coding domain. Some techniques of the present disclosure may adapt traditional models to a cohesive framework for more efficiently handling autonomous coding processes.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may include one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may include one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., prediction techniques, coding techniques, and/or the like) described herein. The external computing entities 108, for example, may include and/or be associated with one or more entities that may be configured to receive, transmit, store, manage, and/or facilitate datasets, such as a lookup tables, vector data stores, and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a target coding domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

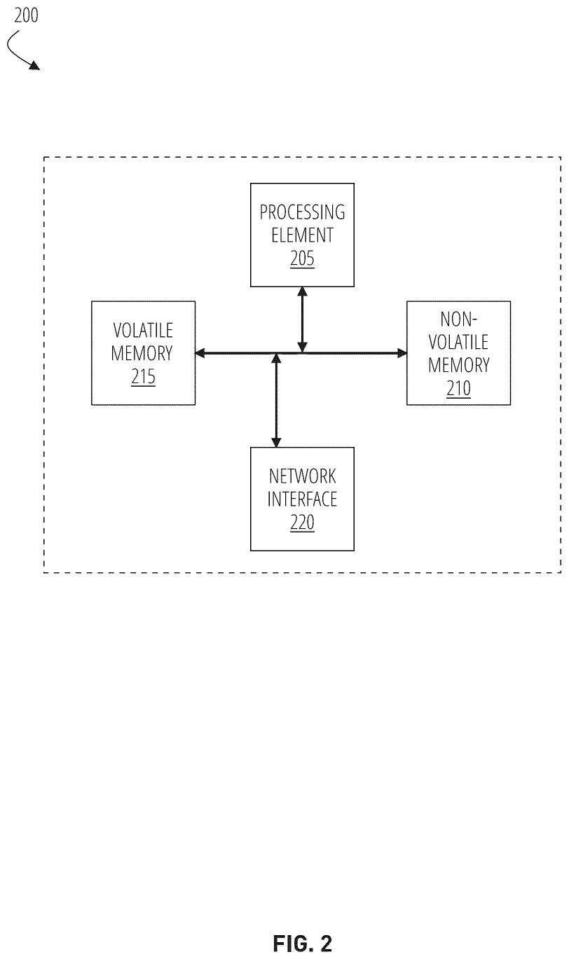

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products include application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

As indicated, in some embodiments, the computing entity 200 may also include one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively include, or be in communication with, one or more input elements/devices, such as input sensor(s). In some examples, the input sensor(s) may include one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively include, or be in communication with, one or more output elements/devices (not shown), such as one or more speakers, visual display devices, haptic feedback devices, motion devices (e.g., electromechanically actuated devices), and/or the like.

### B. Example Client Computing Entity

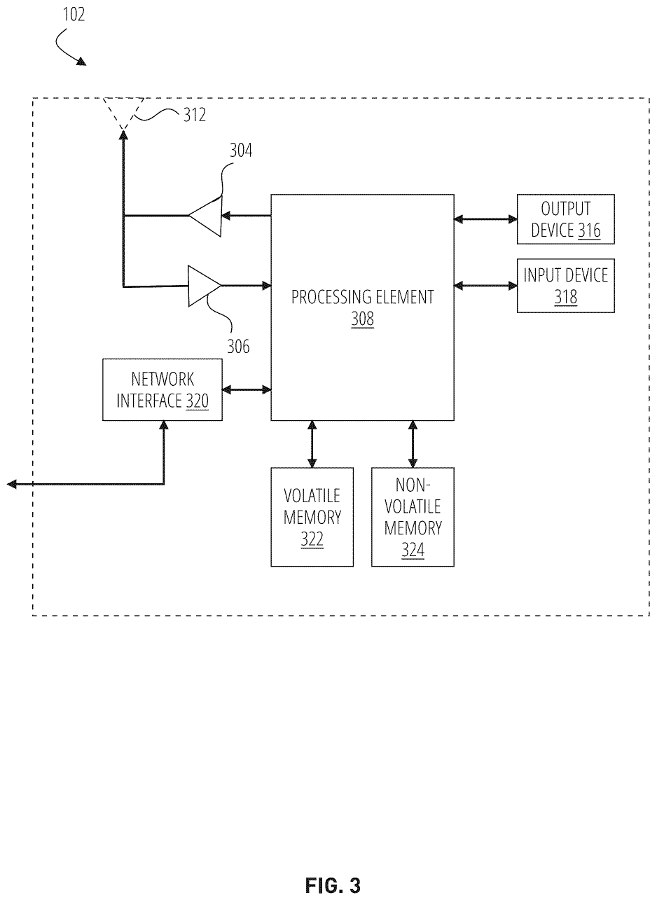

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may include an output device 316 coupled to a processing element 308 and/or a user input device 318 coupled to the processing element 308. An output device 316, for example, may include a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further include, or be in communication with, one or more memory components, such as the volatile memory 322 and/or non-volatile memory 324. For example, the memory components may include non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “code request” refers to a request for a code related to a file, such as a natural language or other type of document, and/or a text segment of a file. A code request, for example, may include an application programming interface (API) call to an automated coding service, such as the multi-stage machine learning automated coding pipeline of the present disclosure. In some examples, a code request may include one or more parameters that identify a file containing natural language, a text segment within a file, text that is otherwise received, e.g., such as by creation of the text by a user, a computing device, or a machine-learned model (e.g., a machine-learned model that converts audio to text). For example, a code request may include an identifier (e.g., uniform resource locator (URL), pointer) for a file containing natural language text. In such a case, the multi-stage machine learning automated coding pipeline may extract one or more text segments from the file and perform an iteration of the multi-stage machine learning automated coding pipeline for up to each of the extracted text segments. In addition, or alternatively, a code request may include and/or identify one or more text segments of a file. By way of example, a code request may be received in response to a selection of one or more text segments in a file.

A code request may include a request to return a code within a coding domain that maps to one or more text segments from a natural language document. For example, in a coding domain, one or more coding systems may assign unique codes to identify an actionable insight to provide a uniform language for effective communication among different participants within the coding domain. These codes bridge communication gaps between participants but require the communications (e.g., medical claims in a healthcare domain, electronic data interchange (EDI) codes exchanged between autonomous computing devices in an EDI domain, vulnerability identifiers in a cybersecurity domain) to be appropriately formatted using the standardized codes which may change and/or otherwise fail to align with the natural language of a particular participant. To address the distinctions between standardized codes and the natural language of a particular participant, a code request may be initiated to translate one or more text segments to a standardized code. By way of example, in a healthcare domain, a code request may request a translation from a natural language description of a medical procedure to a particular medical code for the medical procedure that identifies a compensation, coverage, and/or other actionable insights for the medical procedure.

In some embodiments, the term “code” refers to one or a sequence of characters and/or numerals that describe an actionable insight. A code, for example, may include a representation for an actionable insight (e.g., a medical procedure, a computer vulnerability) within a coding domain. A code may be one of a plurality of codes defined within the coding domain to identify one or more actionable insights. By way of example, in a healthcare domain, a code may include a current procedural terminology (CPT) code including either 5-digit numeric or alphanumeric characters, a list of healthcare common procedure coding system (HCPCS) codes including a single letter followed by four numeric digits, and/or the like.

In some examples, a code may include a codified representation for a textual description that describes the actionable insight corresponding to the code. The textual description, for example, may include a term, a phrase, one or more phrases, sentences, and/or the like. By way of example, in a healthcare domain, a CPT code may include a 5-digit numeric that corresponds to a textual description of a medical procedure.

In some embodiments, the term “coding domain” refers to a prediction space in which a plurality of codes is defined. A coding domain may include any domain in which codes are used to capture an actionable insight. For example, a coding domain may be a computer performance monitoring domain that leverages a plurality of codes to identify defined computing activities, defects, and other features predictive of a computer's performance. Other examples of coding domains may include healthcare domains, autonomous computing device operation domains, cybersecurity and/or other computing domains, and/or the like. As an example, a healthcare domain may leverage a systematic coding of medical procedures and diagnoses for managing the health of participants within a healthcare system. These, medical codes, may include CPT codes, Clinical Modification (CM), Healthcare Common Procedure Coding System (HCPCS) codes, and/or the like that may be assigned to a participant based on the participant's activity within the healthcare domain (e.g., as reflected by a medical chart). CM codes, for example, may include a set of codes developed and maintained by the World Health Organization (WHO) that offers a system for classifying diseases, with detailed categorization of various signs, symptoms, abnormal findings, complaints, social circumstances, and external causes of injury or disease. CPT codes may include another set of codes developed by another agency (e.g., the American Medical Association) that include alphanumeric characters utilized by healthcare providers to document procedures and services performed during a healthcare visit. HCPCS codes may include yet another set of codes developed and maintained by yet another agency for classifying medical procedures and diagnoses.

Coding domains with disparate sets of codes managed by third parties, such as the healthcare example above, present several technical challenges to autonomous coding systems due to the intricate and variable nature of coding languages that may differ across agencies and coding systems. These challenges are exacerbated by participants within coding domains that use their own, individualized language to describe the actionable insights corresponding to the codes. Some embodiments of the present disclosure address these technical challenges using a multi-stage machine learning automated coding pipeline that effectively matches the individualize codes (e.g., codes defined across different agencies and/or coding systems) to the individualized language (e.g., natural language text defined across different participants) used across a coding domain to create universal code to text mappings for downstream processes. In some examples, the multi-stage machine learning automated coding pipeline may leverage one or more data structures to generate, store, and update the universal code to text mappings. A vector data store, for example, may be prepopulated with vectorized representations of codes for use across the multi-stage machine learning automated coding pipeline.

In some embodiments, the term “vector data store” refers to a data structure that indicates a plurality of vectorized representations for a plurality of codes within a coding domain. A vector data store, for example, may include a plurality of code-vector tuples. Each code-vector tuple may include a code, a code vector, and/or a textual description for the code. In some examples, the vector data store may include a code-vector tuple for each code defined within a coding domain (e.g., embeddings for all 18,000 procedural codes defined by the AMA, embeddings for all 260,000+ common vulnerabilities and exploits (CVEs) in the National Vulnerability Database). The size of the vector data store may be based on a total count of codes within a coding domain and/or the dimensions of the plurality of code vectors therein.

In some embodiments, the term “code vector” refers to a vectorized representation of a code. A code vector, for example, may include an embedding that encodes, via machine learning, a semantic meaning of a particular code. In some examples, a code vector may be generated by encoding a textual description associated with a code. For instance, a textual description of a code may be input to a machine learning encoder to receive the code vector. As described herein, embeddings, which represent words, sentences, and/or other data as numerical vectors in a high-dimensional space (i.e., an embedding space) where the position of the embedding is determined as a function of an encoder model's training and represents semantic meaning and contextual relationships between words within a textual description and similarities/differences between the textual description and other textual descriptions. By training an encoder model to increase a distance between embeddings generated for dissimilar textual descriptions and/or decreasing a distance between embeddings generated for similar textual descriptions, an embedding, such as the code vector, may enable a machine learning model to effectively match different embeddings according to a semantic similarity expressed by different embeddings as a function of their location in the embedding space.

In some examples, a code vector may be generated for up to each of a plurality of codes by encoding a plurality of textual descriptions respectively corresponding to the plurality of codes. In some examples, the code vectors may be stored in a vector data store for retrieval during one or more stages of a multi-stage machine learning automated coding pipeline.

In some embodiments, the term “machine learning encoder” refers to a data entity/architecture that describes parameters, hyper-parameters, and/or defined operations of a machine learning model (e.g., model including at least one of one or more rule-based layers, one or more layers that depend on trained parameters, coefficients, and/or the like). A machine learning encoder may include any type of model configured, trained, and/or the like to generate an encoded output, such as an embedding (e.g., code vector, text segment vector), for text. A machine learning encoder may include one or more of any type of machine learning model including one or more supervised, unsupervised, semi-supervised, reinforcement learning models, and/or the like. For instance, a machine learning encoder may include a machine learning language model, such as a bidirectional transformer. By way of example, a machine learning encoder may include a bidirectional encoder-based language model, such as bidirectional encoder representations from transformers (BERT) model, a robustly optimized BERT pretraining approach (RoBERTa) model, and/or the like. In some examples, the machine learning encoder may be part of a large language models (LLM).

In some embodiments, the term “natural language document” refers to a file that contains natural language text. A file, more generally, may include a natural language document, a structured language document, and/or the like that contains text and/or a media format in which text may be derived (e.g., through transcriptions, annotations). A file may store natural language text according to any data format. For example, a file may comprise a data structure of any file format, including an audio file format (e.g., Moving Picture Experts Group (MPEG), Free Lossless Audio Codec (FLAC), Waveform Audio File (WAV)), an image file format (e.g., Joint Photographic Experts Group (JPEG), Portable Network Graphics (PNG), Graphics Interchange Format (GIF)), a video file format (e.g., MP-4, QuickTime Movie (MOV)), a structured file format, unstructured file format (e.g., text file), semi-structured file format (e.g., JavaScript Object Notation (JSON), Extensible Markup Language (XML), Hypertext Markup Language (HTML)), and/or the like.

In some examples, one or more text segments may be extracted, converted, transposed, and/or otherwise derived from a file by identifying a file format and automatically applying one or more different text extraction techniques to the file according to the file format. By way of example, natural language document by parsing the natural language text document into a plurality of text segments of a predetermined size (e.g., one or more words, sentence). In addition, or alternatively, one or more natural language text segments may be extracted from a structured and/or semi-structured file using a natural language processor (e.g., Named Entity Recognition (NER)), a large language model (LLM), a text parser, regular expression (Regex) text processors, and/or the like. In some example, one or more natural language text segments may be extracted from an audio and/or video file by first applying a conversion component, such as audio and/or video transcription service (e.g., audio-to-text LLM) to convert the file to a text format and then parsing (and/or applying another natural language processing technique) to the converted text file to extract the one or more text segments. In some examples, one or more natural language text segments may be extracted from an image file by first applying an annotation service (e.g., computer vision models, such as supervised classification models) to convert the file to a text format and then parsing (and/or applying another natural language processing technique) to the converted text file to extract the one or more text segments.

In some examples, the text extracted from a file may depend on the coding domain. As one example, a file may include a performance report (e.g., computer activity log) reflective of a computing performance of a hardware device. As another example, a file may include a medical coverage document that describe a healthcare coverage for a participant.

In some embodiments, the term “text segment” refers to one or more terms or phrases within a file. A text segment, for example, may include a segment of text that may be related to a defined code within a coding domain. A text segment may depend on a coding domain. For instance, in a computer performance monitoring domain, a text segment may include one or more terms and/or phrases that describe a computer's performance, a condition, and/or the like detected by hardware and/or software sensor(s), using the schema of a particular program and/or file type, operating system, and/or the like. As another example, in a healthcare domain, a text segment may describe a medical term, process, concept, and/or the like, using the words of a healthcare provider. By way of example, a text segment in a healthcare domain may include “non-surgical treatment of obesity,” which may relate to a medical code without matching the medical code's textual description.

In some embodiments, the term “text segment vector” refers to a vectorized representation of a text segment. A text segment vector, for example, may include an embedding that describes a semantic meaning of a text segment. In some examples, a text segment vector may be generated by encoding the text segment using the machine learning encoder. For instance, the text segment may be input to the machine learning encoder to generate the text segment vector. In some examples, the same machine learning encoder may be used to encode both a code and a text segment to generate embeddings that equally weight one or more semantic features expressed by a code's textual description and a text segment.

In some embodiments, the term “searching vector” refers to a code vector from the vector data store that satisfies similarity criteria (e.g., by meeting or exceeding similarity threshold) with respect to a text segment vector. A searching vector, for example, may be a member of a subset of code vectors determined to be relevant to a text segment (e.g., based on a distance between a text segment vector generated for the text segment and the searching vector). The subset of code vectors may be filtered from the plurality of code vectors within the vector data store based on a semantic similarity of the codes represented by the subset of code vectors to a text segment. For example, the subset of code vectors may be determined from among the set of code vectors of a vector data store based on an embedding similarity between the text segment vector and up to each of the code vectors in the set of code vectors. In some examples, the subset of code vectors may include one or more code vectors associated with an embedding similarity that meets or exceeds a similarity threshold (e.g., 0.7, 0.9). In addition, or alternatively, the subset of code vectors may include one or more code vectors associated with a highest k embedding similarity relative the plurality of code vectors, where k is a positive integer. In some examples, the number of code vectors extracted (k) may be set by a tunable code threshold (e.g. 5, 10, 100).

In some examples, the subset of code vectors may be extracted at a first stage of a multi-stage machine learning automated coding pipeline. During the first stage, a machine learning encoder may generate a text segment vector using a text segment. In some examples, the text segment vector is used to conduct a search within the vector data store to determine the top k code vectors that are most similar to the text segment vector of the text segment. In some examples, the similarity metric may include a squared Euclidean (L2) distance. In addition, or alternatively, the similarity metric may include a cosine similarity, dot product, Euclidean distance, Jaccard similarity, and/or the like. By extracting the top k code vectors, a subset of codes with the most similar code vectors to the text segment vector may be short-listed (e.g., saved in cache or other memory for future processing) for subsequent stages of the multi-stage machine learning automated coding pipeline. As described herein, the subset of short-listed codes enables the use of LLMs that traditionally have low recall and precision rates in automated coding pipelines.

In some embodiments, the term “tunable code threshold” refers to a configurable threshold that defines a number of codes extracted in a first stage of the multi-stage machine learning automated coding pipeline. By way of example, the tunable code threshold may define a value for k, such as k=10, which allows the first stage to extract the top 10 codes that have the most similar code vectors to a text segment vector of a text segment. Other examples may include 100, 200, and/or any other number based on the performance of the pipeline. In this way, the tunable code threshold may define a number of a short-listed codes based on their respective code vectors' similarity to a text segment vector.

The tunable code threshold, for example, may include a hyperparameter that may be modifiable based on a performance of the multi-stage machine learning automated coding pipeline. For instance, the tunable code threshold may be increased (e.g., to allow for a larger subset of code vectors) to increase a number of searching vectors applied to subsequent stages of the multi-stage machine learning automated coding pipeline. In addition, or alternatively, the tunable code threshold may be decreased (e.g., to limit the subset of code vectors) to decrease a number of searching vectors applied to subsequent stages of the multi-stage machine learning automated coding pipeline. In some examples, a tunable code threshold may be increased responsive to improve an accuracy of the multi-stage machine learning automated coding pipeline and/or decreased to improve the speed of the multi-stage machine learning automated coding pipeline. In this manner, a tunable code threshold may be tunable to tailor a multi-stage machine learning automated coding pipeline to a particular use case based on the performance requirements for the particular use case.

In some embodiments, the term “generative model prompt” refers to a machine learning prompt for a generative model, such as a Q/A LLM. A generative model prompt, for example, may include a zero-shot prompt, a few shot prompt, and/or the like. In some examples, a generative model prompt may include a modifiable prompt template. The modifiable prompt may comprise a set of pre-configured instructions and a field or other portion into which one or more searching codes and/or the textual descriptions thereof corresponding to one or more searching code vectors (e.g., a subset of the set of code vectors) extracted for the text segment may be inserted. In this manner, a generative model prompt may be configured during a second stage of the multi-stage machine learning automated coding pipeline based on a subset of code vectors extracted in a first, preceding stage of the multi-stage machine learning automated coding pipeline.

In some examples, during the second stage, the generative model prompt may be provided to a generative model, such as a Q/A LLM, in a request to generate a code prediction. The generative model prompt may request a code prediction from a subset of codes (e.g., one or more searching codes) defined within a coding domain. In some examples, the generative model prompt may instruct the Q/A LLM to determine a relevancy for up to each of the subset of codes based on the textual descriptions of the subset of codes, the textual segment, and one or more prompting examples. In this way, during the second stage, a second relevancy test may be performed using a Q/A LLM for direct question answering on a short-listed subset of codes (e.g., searching codes). By doing so, the generative model prompt may improve Q/A LLM performance by reducing the search space and constraining the prediction scope of the Q/A LLM.

By way of example, in a healthcare domain, a generative model prompt may include:

As a proficient medical coder, your responsibility involves determining whether a CPT code specifically corresponds to a medical service. I will provide you with a single medical service along with a list of CPT codes and their descriptions. Your task is to identify the codes from the provided list that are explicitly related to the medical service. It is critical to meticulously analyze the medical service and deliver only those codes that are directly associated with the same kind of service, ensuring precision. The medical service is indicated by < > and the list of codes is marked by [ ]. Please return the pertinent codes, each enclosed within ‘ ’. In cases where none of the codes are relevant, provide an empty list: [ ]. It is preferable to return an empty list rather than codes you are uncertain about or ones that cannot be linked to the term.
Here is an example for you to learn from:
Term: <‘training text segment’>
List of codes and descriptions:
[(First Training Code, First Training Code Textual Description),
[(Second Training Code, Second Training Code Textual Description),
[(Third Training Code, Third Training Code Textual Description),
[(Fourth Training Code, Fourth Training Code Textual Description),
[(Fifth Training Code, Fifth Training Code Textual Description),
[(Sixth Training Code, Sixth Training Code Textual Description),
[(Seventh Training Code, Seventh Training Code Textual Description),
[(Eighth Training Code, Eighth Training Code Textual Description),
[(Ninth Training Code, Ninth Training Code Textual Description),
[(Tenth Training Code, Tenth Training Code Textual Description),
Your response should be [(First Training Code), (Fourth Training Code), (Tenth Training Code)] because from the codes I provided to you, only [(First Training Code), (Fourth Training Code), (Tenth Training Code)] are specific to training text segment.
Now it's your turn. Please do not include any extra text other than the list of relevant codes in your response. Do not include the description. only the code in the format of a list.
Term: <{text segment}>
[Set of Codes and Textual Descriptions]

In some embodiments, the term “prompt template” refers to an instruction set of a generative model prompt. The prompt template, for example, may include preconfigured instructions to the generative model to establish a set of rules for determining a relevancy of a code with respect to the text segment. In some examples, a prompt template may include one or more rule sets, relevancy examples, and/or the like.

In some embodiments, the term “generative model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A generative model may include any type of model configured, trained, and/or the like to generate a code prediction for a text segment. A generative model may include one or more of any type of machine learning model including one or more supervised, unsupervised, semi-supervised, reinforcement learning models, and/or the like. For instance, a generative model may include a decoder-only or encoder-decoder machine-learned model, such as a generative pre-trained transformer, decoding-enhanced BERT with disentangled attention (deBERTa), Nemotron, Qwen2, and/or the like, any of which may be a generative model or LLM. Note that some generative models may be LLMs and vice versa. In some examples, the generative model may include a Q/A generative model, such as a Q/A LLM model, and/or the like. For instance, an example Q/A LLM may comprise a type of sequence-to-sequence (Seq2Seq) model, and/or the like.

In some embodiments, the term “code prediction” refers to an output of a multi-stage machine learning automated coding pipeline. A code prediction may include one or more codes from the subset of codes (e.g., search codes) predicted as being related to a text segment. By way of example, in a healthcare domain, a code prediction may include a list of relevant CPT and/or HCPCS codes that are associated with the medical service.

In some examples, a code prediction may be output (e.g., for presentation to a user via a display, for storage within a lookup table) with the text segment. The code prediction, for example, may be output as a code-text pair (e.g., data entry of a lookup table, selectable icon within a user interface) that includes the code prediction, the text segment, and/or a textual description for each code of the code prediction. In some examples, the code-text pair may be stored in a lookup table to continuously improve computer interpretation of codes over time.

In some embodiments, the term “lookup table” refers to a data structure that stores a plurality of code-text pairs. A lookup table, for example, may include a data table with a plurality data entries. Each entry may include a code-text pair. In some examples, a lookup table may be iteratively generated and/or updated after each iteration of a multi-stage machine learning automated coding pipeline. For example, after each iteration of the multi-stage machine learning automated coding pipeline, a new data entry may be created within the lookup table and a code-text pair may be added as the new data entry. This may allow for quick access to code-text segment mappings that may grow with use of the multi-stage machine learning automated coding pipeline to incrementally adapt the lookup table to a coding domain.

In some embodiments, the term “associated code” refers to a code of a code-text pair.

In some embodiments, the term “lookup request” refers to a request to the lookup table for a code related to a natural language document and/or a text segment thereof. A lookup request, for example, may include an application programming interface (API) call to the lookup table.

In some embodiments, the term “null response” refers to a response to the lookup request. A null response, for example, may include an application programming interface (API) return from the lookup table. The null response may indicate that the lookup table does not include an associated code corresponding to a text segment. In some examples, a null response may trigger the performance of an iteration of the multi-stage machine learning automated coding pipeline to generate a code prediction and/or output (e.g., via a display and/or to the lookup table) a code-text pair.

In some embodiments, the term “code update message” refers to a data entity that describes a modification to one or more of a plurality of defined codes within a coding domain. A code update message may include a data message from a coding system within the coding domain. The code update message may identify a code modification, a code addition, and/or a code removal. A code modification, for example, may identify a modification to a textual description of a code and/or a change to the code itself, a code addition identifying a new code, and/or a code removal identifying a deletion of a code. In some examples, up to each of the code modification, code addition, and the code removal may trigger a corresponding action for the lookup table and/or the vector data store. By way of example, in response to a code addition, the textual description of the code may be encoded to generate a code vector and the code, textual description, and the code vector may be added to the vector data store. In response to a code modification and/or code removal, one or more code-text pairs corresponding to the modified and/or removed code may be deleted from the lookup table.

### IV. OVERVIEW

Various embodiments of the present disclosure provide model pipelines, including machine learning architectures and model sequences that improve the functionality of a computer with respect to various computing tasks, including autonomous coding. To do so, some embodiments of the present disclosure provide a multi-staged machine learning model pipeline that defines a plurality of complementary machine learning stages to generate improved predictions with less computing resources. To overcome performance deficiencies with traditional machine learning models, such as LLMs with traditionally low recall and precision rates within automated coding pipelines, the multi-staged model pipeline adapts embedding techniques to a first stage of a multi-stage process to preemptively reduce a prediction space for later stages of the pipeline. By doing so, the multi-staged model pipeline may improve the performance of downstream models, including by improving the recall and precision rates of downstream LLMs, that allows for the adaptation of traditionally underperforming models (e.g., LLMs) to an autonomous coding process. This, in turn, enables improved predictions that, unlike traditional techniques, may handle a prediction space of any size without reductions in predictive accuracy. By doing so, the multi-staged model pipelines of the present disclosure improve the processing speeds, resource allocation, and storage rates of a computer with respect to automated coding tasks by reducing execution costs for running LLMs, while increasing the recall and precision rates of LLM outputs.

Moreover, traditional coding techniques are limited to fixed and pre-populated tables hosted by different computing systems that may or may not be accessible through network communications. These tables are system specific, remotely located (necessitating an network connect with a plurality of external systems), and are unreliable due to infrequent and unsynchronized update rates. These technical challenges lead to disconnects in communication between parties interacting within a coding domain. The multi-stage process of the present disclosure automates the traditionally subjective coding process by connecting a series of complementary LLMs to reduce the performance costs of executing the LLMs, while improving their results. By doing so, the multi-stage process of the present disclosure enables the creation and maintenance of a universal and centralized translation service between textual segments and codes within a coding domain. By automated the process, the universal and centralized translation service may continuously iterate and, by doing so, augment text-code mappings over time to adapt to changes within the coding domain. This ensures that the list of codes associated with text segments is always up to date. For example, using the techniques of the present disclosure, code mappings may be automatically updated, following code updates, by simplifying the inputs of a coding process to require only the provision of the code modifications as codes are modified overtime. In this manner, the universal and centralized translation service of the present disclosure may reduce network requirements within a coding system, while increasing the reliability and synchronization of code translations within a computing environment. This allows for the reliable use of computer-interpretable codes for downstream computing tasks (e.g., vulnerability detection) that are uniquely vulnerable to coding inaccuracies.

Examples of technologically advantageous embodiments of the present disclosure include improved: (i) model pipelines, (ii) autonomous coding, (iii) request handling, among other aspects of the present disclosure. Other technical improvements and advantages may be realized by one of ordinary skill in the art.

### V. EXAMPLE SYSTEM OPERATIONS

As indicated, various embodiments of the present disclosure make important technical contributions to computer functionality, including machine learning, autonomous coding, and text translation services. In particular, systems and methods are disclosed herein that implement machine learning techniques, such as the multi-stage machine learning automated coding pipeline, to improve LLM performance with respect to various tasks, including autonomous coding. By doing so, and as described herein, the machine learning techniques of the present disclosure improve the precision and recall of LLMs with respect to autonomous coding tasks that, when executed on a computer, reduce the processing, memory, and temporal requirements for autonomous coding as well as downstream computing tasks that rely on computer interpretable codes, such as computer vulnerability detection, and/or the like. Thus, the various embodiments of the present disclosure improve the functionality of a computer with respect to many computing tasks, including computer security, machine learning classification, prediction, and the like.

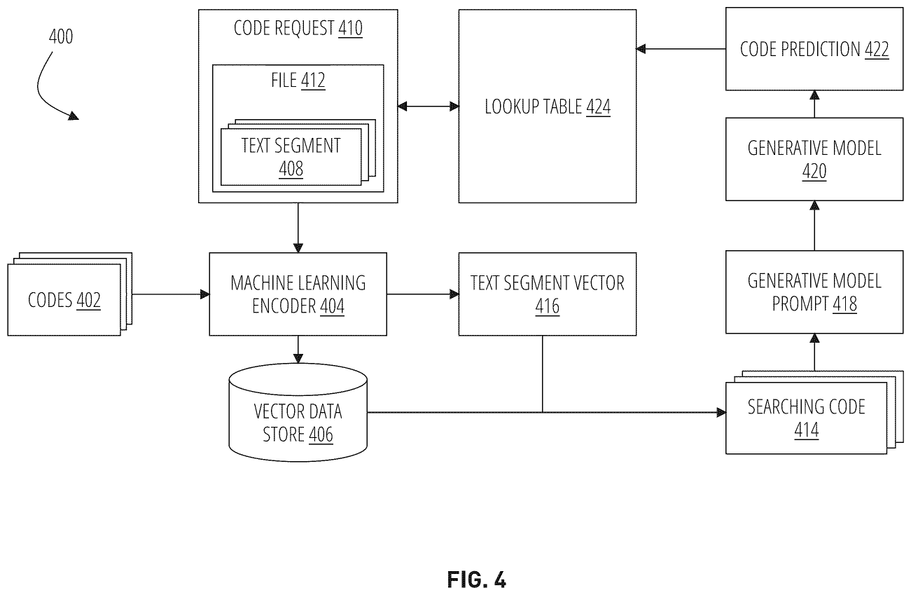

FIG. 4 is a dataflow diagram 400 of a multi-layered autonomous coding framework in accordance with some embodiments of the present disclosure. The multi-layered autonomous coding framework applies a multi-stage machine learning automated coding pipeline to autonomously code text segments 408 within a file 412. The multi-stage machine learning automated coding pipeline may be configured to receive a code request 410 (e.g., from a client device) and, in response to the code request 410, process a text segment 408 to generate a code prediction 422. The code prediction 422 may be returned as a response to the code request 410 to enable selective autonomous coding for a file 412. As shown in the dataflow diagram 400, the multi-stage machine learning automated coding pipeline may be used to maintain a lookup table 424 with a plurality of previously mapped code-text pairs. By doing so, a code request 410 may be preprocessed by searching a lookup table 424 before initiating the multi-stage machine learning automated coding pipeline. This reduces processing resources by limiting iterations of a processing resource intensive coding process to new, previously unseen, or modified, codes within a coding domain.

In some embodiments, a text segment 408 is extracted from a file 412 that includes a plurality of natural language text segments. In addition, or alternatively, a determination may be made that the file 412 does not contain natural language text. In such a case, a conversion component may be determined that is associated with a file type associated with the file 412 and the text segment 408 may be detected from the file 412 based on processing the file 412 using the conversion component.

Once initiated, the multi-stage machine learning automated coding pipeline may process a text segment 408 through multiple, collaborative stages designed to improve the performance of the models called within the multi-stage machine learning automated coding pipeline. This includes, for example, extracting, using embedding techniques, a subset of searching codes 414 from a plurality of codes 402 during a first stage. This first relevancy filter provides a reduced prediction space for downstream models that has specifically shown performance increases for LLMs. During the second stage, searching codes 414 are leveraged to generate a generative model prompt 418 for a generative model 420 to instruct the performance of a second relevancy filter. The output of the generative model 420 may then be returned as a code prediction 422. In this way, the multi-stage machine learning automated coding pipeline may break a coding process into two, complementary stages that enable the use of LLMs, such the generative model 420, for an autonomous coding process in which large generative models traditionally underperform.

In some embodiments, a code request 410 is received that identifies at least one of the file 412 or a text segment 408 from among at least one of structural text or at least another text segment in the file 412. An associated code may be requested from a lookup table 424 based on the text segment 408 and receiving the code request 410. A null response may be received responsive to requesting the associated code. In response to the null response, a text segment vector 416 may be generated. The null response, for example, may indicates that the lookup table 424 does not include the associated code for the text segment 408.

In some embodiments, a code request 410 is a request for a code related to a file 412, such as a natural language or other type of document, and/or a text segment 408 of a file.. A code request 410, for example, may include an API call to an automated coding service, such as the multi-stage machine learning automated coding pipeline of the present disclosure. In some examples, the code request 410 may include one or more parameters the identify the file 412 and/or a text segment 408 within the file 412. For example, the code request 410 may include an identifier (e.g., URL, pointer) for the file 412. In such a case, the multi-stage machine learning automated coding pipeline may extract a plurality of text segments 408 from the file 412 and perform an iteration of the multi-stage machine learning automated coding pipeline for up to each of the extracted text segments 408. In addition, or alternatively, the code request 410 may include and/or identify a text segment 408 of a file 412. By way of example, the code request 410 may be received in response to a selection of a text segment 408 from a file 412.

A code request 410 may include a request to return a code within a coding domain that maps to a text segment 408 from a file 412. For example, in a coding domain, one or more coding systems may assign unique codes to identify an actionable insight to provide a uniform language for effective communication among different participants within the coding domain. These codes bridge communication gaps between participants but require the communications (e.g., medical claims in a healthcare domain) to be appropriately formatted using the standardized codes which may change and/or otherwise fail to align with the natural language of a particular participant. To address the distinctions between standardized codes and the natural language of a particular participant, a code request 410 may be initiated to translate a text segment 408 to a standardized code. By way of example, in a healthcare domain, a code request 410 may request a translation from a natural language description of a medical procedure to a particular medical code for the medical procedure that identifies a compensation, coverage, and/or other actionable insights for the medical procedure.

In some embodiments, the file 412 is a natural language document, a structured language document, and/or the like that contains text and/or a media format in which text may be derived (e.g., through transcriptions, annotations). A file 412 may store natural language text according to any data format. For example, a file 412 may comprise a data structure of any file format, including an audio file format (e.g., Moving Picture Experts Group (MPEG), Free Lossless Audio Codec (FLAC), Waveform Audio File (WAV)), an image file format (e.g., Joint Photographic Experts Group (JPEG), Portable Network Graphics (PNG), Graphics Interchange Format (GIF)), a video file format (e.g., MP-4, QuickTime Movie (MOV)), a structured file format, unstructured file format (e.g., text file), semi-structured file format (e.g., JavaScript Object Notation (JSON), Extensible Markup Language (XML), Hypertext Markup Language (HTML)), and/or the like.

In some examples, one or more text segments 408 may be extracted, converted, transposed, and/or otherwise derived from a file 412 by identifying a file format and automatically applying one or more different text extraction techniques to the file 412 according to the file format. By way of example, natural language document by parsing the natural language text document into a plurality of text segments 408 of a predetermined size (e.g., one or more words, sentence). In addition, or alternatively, one or more natural language text segments 408 may be extracted from a structured and/or semi-structured file 412 using a natural language processor (e.g., Named Entity Recognition (NER)), a large language model (LLM), a text parser, regular expression (Regex) text processors, and/or the like. In some example, one or more natural language text segments may be extracted from an audio and/or video file by first applying a conversion component, such as audio and/or video transcription service (e.g., audio-to-text LLM) to convert the file 412 to a text format and then parsing (and/or applying another natural language processing technique) to the converted text file to extract the one or more text segments 408. In some examples, one or more natural language text segments 408 may be extracted from an image file by first applying an annotation service (e.g., computer vision models, such as supervised classification models) to convert the file 412 to a text format and then parsing (and/or applying another natural language processing technique) to the converted text file to extract the one or more text segments 408.

In some examples, the text extracted from a file 412 may depend on the coding domain. As one example, a file 412 may include a performance report (e.g., computer activity log) reflective of a computing performance of a hardware device. As another example, a file 412 may include a medical coverage document that describe a healthcare coverage for a participant

In some embodiments, a text segment 408 is one or more terms or phrases within a file 412. A text segment 408, for example, may include a segment of text that may be related to a defined code within a coding domain. The text segment 408 may depend on a coding domain. For instance, in a computer performance monitoring domain, the text segment 408 may include one or more terms and/or phrases that describe a computer's performance, a condition, and/or the like, using the words of a particular program, operating system, and/or the like. As another example, in a healthcare domain, the text segment 408 may describe a medical term, process, concept, and/or the like, using the words of a healthcare provider. By way of example, the text segment 408 in a healthcare domain may include “non-surgical treatment of obesity,” which may relate to a medical code without matching a medical code's textual description.

In some embodiments, the text segment 408 from the file 412 is input to a machine learning encoder 404 to generate a text segment vector 416.

In some embodiments, the machine learning encoder 404 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning encoder 404 may include any type of model configured, trained, and/or the like to generate an encoded output, such as an embedding (e.g., code vector, text segment vector 416), for text. The machine learning encoder 404 may include one or more of any type of machine learning model including one or more supervised, unsupervised, semi-supervised, reinforcement learning models, and/or the like. For instance, a machine learning encoder 404 may include a machine learning language model, such as a bidirectional transformer. By way of example, a machine learning encoder 404 may include a bidirectional encoder-based language model, such as a BERT model, a RoBERTa model, and/or the like. For example, the machine learning encoder 404 may include one or more LLMs.

In some embodiments, the text segment vector 416 is a vectorized representation of a text segment 408. A text segment vector 416, for example, may include an embedding that describes a semantic meaning of the text segment 408. In some examples, the text segment vector 416 may be generated by encoding the text segment 408 using the machine learning encoder 404. For instance, the text segment 408 may be input to the machine learning encoder 404 to receive the text segment vector 416. In some examples, the same machine learning encoder 404 may be used to encode both a code and a text segment 408 to generate embeddings that equally weight one or more semantic features expressed by a code's textual description and the text segment 408.

In some embodiments, a subset of searching codes 414 is extracted from a vector data store 406 based on a comparison between the text segment vector 416 and a plurality of code vectors within the vector data store 406. For example, the subset of searching codes 414 may be determined from a set of codes of the vector data store 406 based on determining a distance between the text segment vector 416 and a first code vector associated with a first searching code of the subset of searching codes 414. In some examples, the set of code vectors may be previously generated using the machine learning encoder. The first code vector may be generated by the machine learning encoder based on the first searching code and the first searching code may be a first code of the set of codes.

In some examples, the number of codes within the subset of searching codes 414 may be based on a tunable code threshold.

In some embodiments, a code one or a sequence of characters and/or numerals that describe an actionable insight. The codes 402, for example, may include a representations for an actionable insights (e.g., a medical procedure, a computer defect) within a coding domain. Each code may be one of a plurality of codes 402 defined within the coding domain to identify one or more actionable insights. By way of example, in a healthcare domain, a code may include a current procedural terminology (CPT) code including either 5-digit numeric or alphanumeric characters, a list of healthcare common procedure coding system (HCPCS) codes including a single letter followed by four numeric digits, and/or the like.

In some examples, a code may include a codified representation for a textual description that describes the actionable insight corresponding to the code. The textual description, for example, may include a term, a phrase, one or more phrases, sentences, and/or the like. By way of example, in a healthcare domain, a CPT code may include a 5-digit numeric that corresponds to a textual description of a medical procedure.

In some embodiments, a coding domain is a prediction space in which a plurality of codes 402 is defined. A coding domain may include any domain in which codes 402 are used to capture an actionable insight. For example, a coding domain may be a computer performance monitoring domain that leverages a plurality of codes 402 to identify defined computing activities, defects, and other features predictive of a computer's performance. Other examples of coding domains may include healthcare domains, business domains, financial domains, and/or the like. As an example, a healthcare domain may leverage a systematic coding of medical procedures and diagnoses for managing the health of participants within a healthcare system. These, medical codes, may include CPT, CM, HCPCS codes, and/or the like that may be assigned to a participant based on the participant's activity within the healthcare domain (e.g., as reflected by a medical chart). CM codes, for example, may include a set of codes developed and maintained by the WHO that offers a system for classifying diseases, with detailed categorization of various signs, symptoms, abnormal findings, complaints, social circumstances, and external causes of injury or disease. CPT codes may include another set of codes developed by another agency (e.g., the American Medical Association) that include alphanumeric characters utilized by healthcare providers to document procedures and services performed during a healthcare visit. HCPCS codes may include yet another set of codes developed and maintained by yet another agency for classifying medical procedures and diagnoses.

Coding domains with disparate sets of codes 402 managed by third parties, such as the healthcare example above, present several technical challenges to autonomous coding systems due to the intricate and variable nature of coding languages that may differ across agencies and coding systems. These challenges are exacerbated by participants within coding domains that use their own, individualized language to describe the actionable insights corresponding to the codes 402. Some embodiments of the present disclosure address these technical challenges using a multi-stage machine learning automated coding pipeline that effectively matches the individualize codes (e.g., codes defined across different agencies and/or coding systems) to the individualized language (e.g., natural language text defined across different participants) used across a coding domain to create universal code to text mappings for downstream processes. In some examples, the multi-stage machine learning automated coding pipeline may leverage one or more data structures to generate, store, and update the universal code to text mappings. A vector data store 406, for example, may be prepopulated with vectorized representations of codes 402 for use across the multi-stage machine learning automated coding pipeline.

In some embodiments, the vector data store 406 is a data structure that describes a plurality of vectorized representations for a plurality of codes 402 within a coding domain. A vector data store 406, for example, may include a plurality of code-vector tuples. Each code-vector tuple may include a code, a code vector, and/or a textual description for the code. In some examples, the vector data store may include a code-vector tuple for each code defined within a coding domain (e.g., embeddings for all 18,000 procedural codes defined by the AMA, embeddings for all 260,000+ common vulnerabilities and exploits (CVEs) in the National Vulnerability Database The size of the vector data store 406 may be based on a total count of codes within a coding domain and/or the dimensions of the plurality of code vectors therein.

In some embodiments, the code vector is a vectorized representation of a code. A code vector, for example, may include an embedding that describes a semantic meaning of a code. In some examples, a code vector may be generated by encoding a textual description of a code. For instance, a textual description of a code may be input to the machine learning encoder 404 to receive the code vector. As described herein, embeddings, which involve representing words or sentences as numerical vectors in a high-dimensional space, may be leveraged to capture the semantic meaning and contextual relationships between words within a textual description. By doing so, an embedding, such as the code vector, may enable a machine learning model to effectively match different embeddings according to a semantic similarity expressed by different embeddings.

In some examples, a code vector may be generated for up to each of a plurality of codes 402 by encoding a plurality of textual descriptions respectively corresponding to the plurality of codes 402. In some examples, the code vectors may be stored in a vector data store 406 for retrieval during one or more stages of a multi-stage machine learning automated coding pipeline.

In some embodiments, the subset of searching codes 414 is extracted from the vector data store 406 based on a subset of searching vectors identified within the vector data store 406. In some embodiments, a searching vector is a code vector from the vector data store 406 that satisfies a similarity criterion with respect to a text segment vector. For example, determining whether a searching vector satisfies a similarity criterion with respect to a text segment vector may include determining that a first similarity score between the searching vector and the text segment vector meets or exceeds a first similarity threshold in an example where higher values of the similarity score indicate increased similarity. In addition, or alternatively, determining whether a searching vector satisfies a similarity criterion with respect to a text segment vector may include determining that a second similarity score between the searching vector and the text segment vector is less than a second similarity threshold in an example where lesser values of the similarity score indicate increased similarity (e.g., where the similarity score is based at least in part on a distance in an embedding space).

In some examples, a searching vector may be a member of a subset of code vectors determined to be relevant to a text segment 408 (e.g., based on a distance between a text segment vector 416 generated for the text segment 408 and the searching vector). The subset of code vectors may be filtered from the plurality of code vectors within the vector data store 406 based on a semantic similarity of the codes represented by the subset of code vectors to a text segment 408. For example, the subset of code vectors may be determined from among the set of code vectors of a vector data store 406 based on an embedding similarity between the text segment vector 416 and up to each of the code vectors in the set of code vectors. In some examples, the subset of code vectors may include one or more code vectors associated with an embedding similarity that satisfies a similarity threshold (e.g., a first or second similarity threshold). In addition, or alternatively, the subset of code vectors may include one or more code vectors associated with a highest k embedding similarity relative the plurality of code vectors, where k is a positive integer. In some examples, the number of code vectors extracted (k) may be set by a tunable code threshold (e.g. 5, 10, 100).

In some examples, the subset of code vectors may be extracted at a first stage of a multi-stage machine learning automated coding pipeline. During the first stage, a machine learning encoder 404 may generate a text segment vector 416 using a text segment 408. In some examples, the text segment vector 416 is used to conduct a search within the vector data store 406 to determine the top k code vectors that are most similar to the text segment vector 416 of the text segment 408. In some examples, the similarity metric may include a squared Euclidean (L2) distance. In addition, or alternatively, the similarity metric may include a cosine similarity, dot product, Euclidean distance, Jaccard similarity, and/or the like. By extracting the top k code vectors, a subset of codes (e.g., searching codes 414) with the most similar code vectors to the text segment vector 416 may be short-listed (e.g., saved in cache or other memory for future processing) for subsequent stages of the multi-stage machine learning automated coding pipeline. As described herein, the subset of short-listed codes enables the use of LLMs that traditionally have low recall and precision rates in automated coding pipelines.

In some embodiments, a tunable code threshold is a configurable threshold that defines a number of codes extracted in a first stage of the multi-stage machine learning automated coding pipeline. By way of example, the tunable code threshold may define a value for k, such as k=10, which allows the first stage to extract the top 10 codes that have the most similar code vectors to a text segment vector 416 of a text segment 408. Other examples may include 100, 200, and/or any other number based on the performance of the pipeline. In this way, the tunable code threshold may define a number of a short-listed codes (e.g., searching codes 414) based on their respective code vectors' similarity to a text segment vector 416.

The tunable code threshold, for example, may include a hyperparameter that may be modifiable based on a performance of the multi-stage machine learning automated coding pipeline. For instance, the tunable code threshold may be increased (e.g., to allow for a larger subset of code vectors) to increase a number of searching codes 414 applied to subsequent stages of the multi-stage machine learning automated coding pipeline. In addition, or alternatively, the tunable code threshold may be decreased (e.g., to limit the subset of code vectors) to decrease a number of searching codes 414 applied to subsequent stages of the multi-stage machine learning automated coding pipeline. In some examples, a tunable code threshold may be increased responsive to improve an accuracy of the multi-stage machine learning automated coding pipeline and/or decreased to improve the speed of the multi-stage machine learning automated coding pipeline. In this manner, a tunable code threshold may be tunable to tailor a multi-stage machine learning automated coding pipeline to a particular use case based on the performance requirements for the particular use case.

In some embodiments, a generative model prompt 418 is generated based on the subset of searching codes 414. For example, a prompt template may be received and the modified to reference the subset of searching codes 414. In some examples, the prompt template may include a few shot prompt and the generative model 420 may include a Q/A generative model.

In some embodiments, the generative model prompt 418 is a machine learning prompt for a generative model, such as a Q/A LLM. A generative model prompt 418, for example, may include a zero-shot prompt, a few shot prompt, and/or the like. In some examples, a generative model prompt 418 may include a modifiable prompt template. The modifiable prompt may comprise a set of pre-configured instructions and a field or other portion into which one or more searching codes 414 and/or the textual descriptions thereof corresponding to one or more searching code vectors (e.g., a subset of the set of code vectors) extracted for the text segment may be inserted. In this manner, a generative model prompt 418 may be configured during a second stage of the multi-stage machine learning automated coding pipeline based on a subset of code vectors extracted in a first, preceding stage of the multi-stage machine learning automated coding pipeline.

In some examples, during the second stage, the generative model prompt 418 may be provided to a generative model 420, such as a Q/A LLM, in a request to generate a code prediction. The generative model prompt 418 may request a code prediction from a subset of codes (e.g., one or more searching codes 414) defined within a coding domain. In some examples, the generative model prompt 418 may instruct the Q/A LLM to determine a relevancy for up to each of the subset of codes based on the textual descriptions of the subset of codes, the textual segment, and one or more prompting examples. In this way, during the second stage, a second relevancy test may be performed using a Q/A LLM for direct question answering on a short-listed subset of codes (e.g., searching codes 414). By doing so, the generative model prompt 418 may improve Q/A LLM performance by reducing the search space and constraining the prediction scope of the Q/A LLM.

By way of example, in a healthcare domain, a generative model prompt 418 may include:
As a proficient medical coder, your responsibility involves determining whether a CPT code specifically corresponds to a medical service. I will provide you with a single medical service along with a list of CPT codes and their descriptions. Your task is to identify the codes from the provided list that are explicitly related to the medical service. It is critical to meticulously analyze the medical service and deliver only those codes that are directly associated with the same kind of service, ensuring precision. The medical service is indicated by < > and the list of codes is marked by [ ]. Please return the pertinent codes, each enclosed within ‘ ’. In cases where none of the codes are relevant, provide an empty list: [ ]. It is preferable to return an empty list rather than codes you are uncertain about or ones that cannot be linked to the term.
Here is an example for you to learn from:
Term: <‘training text segment’>
List of codes and descriptions:
[(First Training Code, First Training Code Textual Description),
[(Second Training Code, Second Training Code Textual Description),
[(Third Training Code, Third Training Code Textual Description),
[(Fourth Training Code, Fourth Training Code Textual Description),
[(Fifth Training Code, Fifth Training Code Textual Description),
[(Sixth Training Code, Sixth Training Code Textual Description),
[(Seventh Training Code, Seventh Training Code Textual Description),
[(Eighth Training Code, Eighth Training Code Textual Description),
[(Ninth Training Code, Ninth Training Code Textual Description),
[(Tenth Training Code, Tenth Training Code Textual Description),
Your response should be [(First Training Code), (Fourth Training Code), (Tenth Training Code)] because from the codes I provided to you, only [(First Training Code), (Fourth Training Code), (Tenth Training Code)] are specific to training text segment.
Now it's your turn. Please do not include any extra text other than the list of relevant codes in your response. Do not include the description. only the code in the format of a list.
Term: <{text segment}>
[Set of Codes and Textual Descriptions]

In some embodiments, the prompt template is an instruction set of a generative model prompt 418. The prompt template, for example, may include preconfigured instructions to the LLM to establish a set of rules for determining a relevancy of a code with respect to the text segment 408. In some examples, a prompt template may include one or more rule sets, relevancy examples, and/or the like.

In some embodiments, a code prediction 422 is generated for the text segment 408 based on the generative model prompt 418. For instance, the generative model prompt 418 may be input to the generative model 420 to generate a code prediction 422 for the text segment 408.

In some embodiments, the generative model 420 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The generative model 420 may include any type of model configured, trained, and/or the like to generate a code prediction 422 for a text segment 408. For instance, a generative model 420 may include a decoder-only or encoder-decoder machine-learned model, such as a generative pre-trained transformer, decoding-enhanced BERT with disentangled attention (deBERTa), Nemotron, Qwen2, and/or the like, any of which may be a generative model 420 or LLM. Note that some generative models 420 may be LLMs and vice versa. In some examples, the generative model 420 may include a Q/A generative model, such as a Q/A LLM model, and/or the like. For instance, an example Q/A LLM may comprise a type of sequence-to-sequence (Seq2Seq) model, and/or the like

In some embodiments, the code prediction 422 is an output of a multi-stage machine learning automated coding pipeline. A code prediction 422 may include one or more codes from the subset of codes (e.g., search codes 414) predicted as being related to a text segment 408. By way of example, in a healthcare domain, a code prediction 422 may include a list of relevant CPT and/or HCPCS codes that are associated with the medical service.

In some examples, a code prediction 422 may be output (e.g., for presentation to a user via a display, for storage within a lookup table 424) with the text segment 408. The code prediction 422, for example, may be output as a code-text pair (e.g., data entry of a lookup table 424, selectable icon within a user interface) that includes the code prediction 422, the text segment 408, and/or a textual description for each code of the code prediction 422. In some examples, the code-text pair may be stored in a lookup table 424 to continuously improve computer interpretation of codes over time.

In some embodiments, the code prediction 422 is stored in the lookup table 424 with the text segment 408. In some embodiments, the lookup table 424 is a data structure that stores a plurality of code-text pairs. The lookup table 424, for example, may include a data table with a plurality data entries. Each entry may include a code-text pair. In some examples, the lookup table 424 may be iteratively generated and/or updated after each iteration of a multi-stage machine learning automated coding pipeline. For example, after each iteration of the multi-stage machine learning automated coding pipeline, a new data entry may be created within the lookup table 424 and a code-text pair may be added as the new data entry. This may allow for quick access to code-text segment mappings that may grow with use of the multi-stage machine learning automated coding pipeline to incrementally adapt the lookup table 424 to a coding domain. In some embodiments, an associated code is a code of a code-text pair.

In some embodiments, a lookup request is a request to the lookup table 424 for a code related to a file 412 and/or a text segment 408 thereof. A lookup request, for example, may include an API call to the lookup table that requests a preemptive code prediction 422 from the lookup table 424. In some embodiments, a null response is a response to the lookup request. A null response, for example, may include an API return from the lookup table 424. The null response may indicate that the lookup table 424 does not include an associated code corresponding to a text segment 408. In some examples, a null response may trigger the performance of an iteration of the multi-stage machine learning automated coding pipeline.

In some embodiments, a code update message is received that identifies one or more code modifications to one or more codes of a plurality of codes 402 respectively corresponding to the plurality of code vectors. In response to the one or more code modifications, one or more code-text pairs from the lookup table 424 may be removed that respectively correspond to the one or more codes. In addition, or alternatively, a code update message may identify one or more code additions to a plurality of codes 402 respectively corresponding to the plurality of code vectors. One or more code additions may be input to the machine learning encoder to generate one or more additional code vectors. In some examples, the one or more additional code vectors may be stored in the vector data store 406 with the one or more additional codes.

In some embodiments, the code update message is a data entity that describes a modification to one or more of a plurality of defined codes 402 within a coding domain. A code update message may include a data message from a coding system within the coding domain. The code update message may identify a code modification, a code addition, and/or a code removal. A code modification, for example, may identify a modification to a textual description of a code, a code addition may identify a new code, and/or a code removal may identify a deletion of a code. In some examples, up to each of the code modification, code addition, and/or the code removal may trigger an action for the lookup table 424 and/or the vector data store 406. By way of example, in response to a code addition, the textual description of the code may be encoded to generate a code vector and the code, textual description, and the code vector may be added to the vector data store 406. In response to a code modification and/or code removal, one or more code-text pairs corresponding to the modified and/or removed code may be deleted from the lookup table 424.

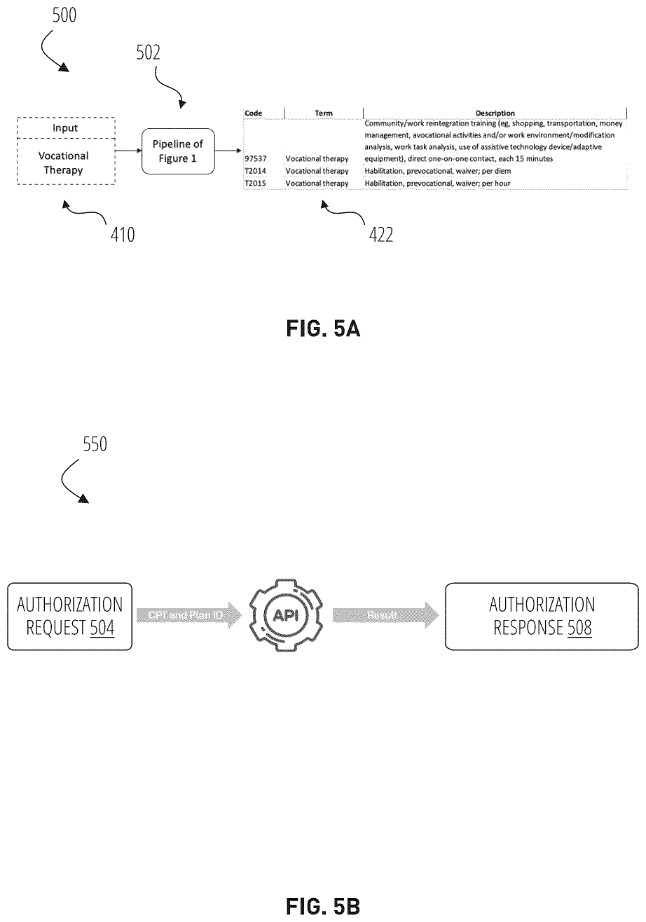

In this manner, the multi-stage machine learning automated coding pipeline may continuously monitor and update code mappings within a dynamically changing coding domain. By doing so, the multi-stage machine learning automated coding pipeline may enable autonomous coding for various prediction spaces, including healthcare coding domains, and/or the like, which will be described in further detail with reference to FIGS. 5A-B.

FIG. 5A-B are operation examples of an autonomous coding process in accordance with one or more embodiments of the present disclosure. FIG. 5A, for example, is an operational example 500 of a healthcare coding process that leverages the multi-stage machine learning automated coding pipeline 502 in accordance with some embodiments of the present disclosure. In a healthcare coding process, various text segments, such as vocational therapy, may be used to define a codified concept within the healthcare domain. To accommodate for nuanced language differences between participants within a healthcare domain, a code request 410 may be initiated for the multi-stage machine learning automated coding pipeline 502 that includes the text segment used by a particular participant. The text segment 408 may be processed by the multi-stage machine learning automated coding pipeline 502 to receive a code prediction 422 that describes one or more codes within the coding domain that may correspond to the text segment.

FIG. 5B is an operational example 550 of an authorization process that leverages the multi-stage machine learning automated coding pipeline 502 in accordance with some embodiments of the present disclosure. In some examples, the multi-stage machine learning automated coding pipeline 502 may be leveraged for downstream process that use code predictions 422 to authorize an activity, perform an action, and/or the like. In such a case, the code request may include an authorization request 504 that may request an authorization, a downstream action, and/or the like based on an uncodified text segment. In such a case, the multi-stage machine learning automated coding pipeline 502 may process the text segment during an autonomous coding stage to output a code prediction. Thereafter, the code prediction may be input to a downstream process to generate an authorization response 508 that authorizes and/or initiates a prediction-based action based on the code prediction 422.

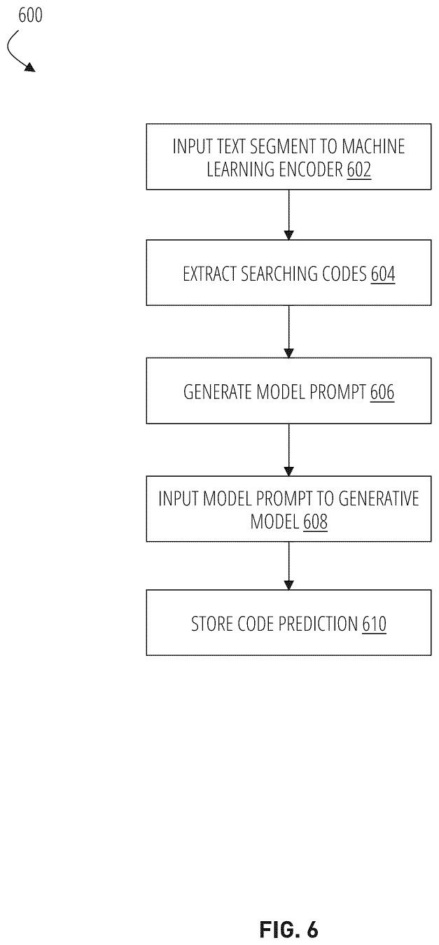

FIG. 6 is a flowchart diagram of an example process 600 for implementing a multi-stage machine learning automated coding pipeline in accordance with some embodiments of the present disclosure. The flowchart depicts a multi-stage machine learning automated coding pipeline that leverages a multiple, complementary machine learning models to autonomously code a text segment without user input. The process 600 may be implemented by one or more computing devices, entities, and/or systems described herein. For example, via the various steps/operations of the process 600, the computing system 101 may leverage improved machine learning architectures to implement a multi-staged approach to autonomous coding that enables the use of models, such as LLMs, that traditionally underperform in such contexts. By doing so, the process 600 provides improvements to machine learning technology that may be applied in various technical fields, such as autonomous coding, etc., to improve the functionality of computer.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 is performed for a text segment from an input file. The file may include a plurality of text segments, such as from a natural language document. In addition, or alternatively, the computing system 101 may determine that the file does not contain natural language text. In such a case, the computing system 101 may determine a conversion component associated with a file type associated with the file and detect the text segment from the file based on processing the file using the conversion component.

In some embodiments, the process 600 includes, at step/operation 602, inputting a text segment to a machine learning encoder. For example, the computing system 101 may generate, by a machine learning encoder, a text segment vector using the text segment from the file.

In some embodiments, the computing system 101 receives a code request that identifies at least one of the file or the text segment from among at least one of structural text or at least another text segment in the file. The computing system 101 requests an associated code from a lookup table based on the text segment and receiving the code request. The computing system 101 receives a null response responsive to requesting the associated code and, in response to the null response, generates the text segment vector.

In some embodiments, the process 600 includes, at step/operation 604, extracting a subset of searching codes. For example, the computing system 101 may determine the subset of searching codes from a set of codes based on determining a distance between the text segment vector and a first code vector associated with a first searching code of the subset of searching codes. In some examples, the set of code vectors is previously generated using the machine learning encoder. The first code vector may be generated by the machine learning encoder based on the first searching code and the first searching code may be a first code of the set of codes. In some examples, the number of codes within the subset of searching codes is determined based on a tunable code threshold.

In some embodiments, the process 600 includes, at step/operation 606, generating a generative model prompt. For example, the computing system 101 may generate a generative model prompt based on the subset of searching codes. For instance, the computing system 101 may receive a prompt template and modify the prompt template to indicate the subset of searching codes. In some examples, the prompt template may include a few shot prompt and the generative model may include a Q/A LLM.

In some embodiments, the process 600 includes, at step/operation 608, inputting the generative model prompt to a generative model. For example, the computing system 101 may generate, by a generative model, a code prediction for the text segment based on the generative model prompt.

In some embodiments, the process 600 includes, at step/operation 610, storing a code prediction. For example, the computing system 101 may store the code prediction in a lookup table in association with the text segment as a first code-text pair.

In some embodiments, the process 600 may further include receiving a code update message identifying one or more code modifications to one or more codes of a plurality of codes respectively corresponding to the plurality of code vectors and, in response to the one or more code modifications, performing an operation. For example, the computing system 101 may receive the code update message identifying one or more code modifications to one or more codes of the plurality of codes respectively corresponding to the plurality of code vectors. In response to the one or more code modifications, the computing system 101 may remove one or more code-text pairs from the lookup table that respectively correspond to the one or more codes, generate, by the machine learning encoder, one or more additional code vectors using one or more additional code vectors indicated by the one or more code modifications, and/or store the one or more additional code vectors in the vector data store in association with the one or more additional code vectors.

Some techniques of the present disclosure enable the generation of action outputs that may be performed to initiate one or more real world actions to achieve real-world effects. The techniques of the present disclosure may be used, applied, and/or otherwise leveraged to extract codes reflective of actionable insights that may depend on a coding domain. These actionable insights, for example, may trigger action outputs (e.g., through control instructions) to automate computer performance action, clinical actions, and/or the like. The action outputs may control various aspects of a client device, such as the display, transmission, and/or the like of data reflective of codes, etc. In some embodiments, codes may trigger an alert, and/or the like. The alert may be automatically communicated to a user and/or be used to initiate a security protocol (e.g., locking a computer), a robotic action (e.g., performing an automated screening process), and/or the like.

In some examples, the computing tasks may include actions that may be based on a coding domain. A coding domain may include any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may include the initiation of automated instructions across and between devices, automated notifications, automated scheduling operations, automated precautionary actions, automated security actions, automated data processing actions, and/or the like.

### VI. CONCLUSION

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” or the like means that a particular element, feature, structure, or characteristic described in connection with the embodiment is included in at least one embodiment, but not every embodiment necessarily includes the particular element, feature, structure, or characteristic. Different instances of the phrase “in one embodiment” in various places in the specification do not necessarily all refer to the same embodiment, although they may in some cases.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### VII. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising generating, by one or more processors and a machine learning encoder, a text segment vector using a text segment from a file; determining, by the one or more processors, a subset of searching codes from a set of codes based on determining a distance between the text segment vector and a first code vector associated with a first searching code of the subset of searching codes; generating, by the one or more processors, a generative model prompt based on the subset of searching codes; and generating, by the one or more processors and a generative model, a code prediction for the text segment based on the generative model prompt.

Example 2. The computer-implemented method of any of the preceding examples, wherein (i) a set of code vectors is previously generated for the set of codes using the machine learning encoder, (ii) the first code vector is generated by the machine learning encoder based on the first searching code, and (iii) the first searching code is a first code of the set of codes.

Example 3. The computer-implemented method of any of the preceding examples, further comprising storing the code prediction in a lookup table in association with the text segment as a first code-text pair.

Example 4. The computer-implemented method of example 3, further comprising receiving a code update message identifying (a) one or more code modifications to one or more codes of the set of codes or (b) one or more additional codes to the set of codes; and in response to the code update message, at least one of removing one or more code-text pairs from the lookup table that respectively correspond to the one or more codes indicated by the one or more code modifications; generating, by the machine learning encoder, one or more additional code vectors using the one or more additional codes; or storing the one or more additional codes in a vector data store in association with the one or more additional code vectors.

Example 5. The computer-implemented method of any of examples 3 through 4, further comprising receiving a code request that identifies at least one of the file or the text segment from among at least one of structural text or at least another text segment in the file; requesting an associated code from the lookup table based on the text segment and receiving the code request; receiving a null response responsive to requesting the associated code; and in response to the null response, generating the text segment vector.

Example 6. The computer-implemented method of example 5, further comprising determining that the file does not contain natural language text; determining a conversion component associated with a file type associated with the file; and detecting the text segment from the file based on processing the file using the conversion component.

Example 7. The computer-implemented method of any of the preceding examples, wherein generating the generative model prompt based on the subset of searching codes comprises receiving a prompt template and modifying the prompt template to indicate the subset of searching codes.

Example 8. The computer-implemented method of example 7, wherein the prompt template comprises a few-shot prompt and the generative model comprises a question answering (Q/A) large language model (LLM).

Example 9. The computer-implemented method of any of the preceding examples, wherein the number of codes within the subset of searching codes is determined based on a tunable code threshold.

Example 10. A system comprising one or more processors; and at least one memory storing processor-executable instructions that, when executed by the one or more processors, cause the one or more processors to perform operations comprising generating, using a machine learning encoder, a text segment vector using a text segment; determining a subset of searching codes from a set of codes based on determining a distance between the text segment vector and a first code vector associated with a first searching code of the subset of searching codes; generating a generative model prompt based on the subset of searching codes; and generating, using a generative model, a code prediction for the text segment based on the generative model prompt.

Example 11. The system of example 10, wherein the text segment is extracted from a natural language document.

Example 12. The system of any of examples 10 through 11, wherein (i) a set of code vectors is previously generated for the set of codes using the machine learning encoder, (ii) the first code vector is generated by the machine learning encoder based on the first searching code, and (iii) the first searching code is a first code of the set of codes.

Example 13. The system of any of examples 10 through 12, wherein the operations further comprise storing the code prediction in a lookup table in association with the text segment as a first code-text pair.

Example 14. The system of example 13, wherein the operations further comprise receiving a code update message identifying (a) one or more code modifications to one or more codes of the set of codes or (b) one or more additional codes to the set of codes; and in response to the code update message, at least one of removing one or more code-text pairs from the lookup table that respectively correspond to the one or more codes indicated by the one or more code modifications; generating, by the machine learning encoder, one or more additional code vectors using the one or more additional codes; or storing the one or more additional codes in a vector data store in association with the one or more additional code vectors.

Example 15. The system of any of examples 13 through 14, wherein the operations further comprise receiving a code request that identifies at least one of a file or the text segment from among at least one of structural text or at least another text segment in the file; requesting an associated code from the lookup table based on the text segment and receiving the code request; receiving a null response responsive to requesting the associated code; and in response to the null response, generating the text segment vector.

Example 16. The system of example 15, wherein the operations further comprise determining that the file does not contain natural language text; determining a conversion component associated with a file type associated with the file; and detecting the text segment from the file based on processing the file using the conversion component.

Example 17. The system of any of examples 10 through 16, wherein to generate the generative model prompt based on the subset of searching codes the operations further comprise receiving a prompt template, and modifying the prompt template to indicate the subset of searching codes.

Example 18. The system of claim 17, wherein the prompt template comprises a few shot prompt and the generative model comprises a Q/A LLM.

Example 19. One or more non-transitory computer-readable storage media storing instructions that, when executed by one or more processors, cause the one or more processors to perform operations comprising generating, using a machine learning encoder, a text segment vector using a text segment; determining a subset of searching codes from a set of codes based on determining a distance between the text segment vector and a first code vector associated with a first searching code of the subset of searching codes; generating a generative model prompt based on the subset of searching codes; and generating, using a generative model, a code prediction for the text segment based on the generative model prompt.

Example 20. The one or more non-transitory computer-readable storage media of example 19, wherein the text segment is extracted from a natural language document.

Example 21. The computer-implemented method of example 1, wherein the method further comprises training the machine learning encoder and the generative model.

Example 22. The computer-implemented method of example 21, wherein the training is performed by the one or more processors.

Example 23. The computer-implemented method of example 21, wherein the one or more processors are included in a first computing entity; and the training is performed by one or more other processors included in a second computing entity.

Example 24. The system of example 10, wherein the one or more processors are further configured to train the machine learning encoder and the generative model.

Example 25. The system of example 24, wherein the one or more processors are included in a first computing entity; and the machine learning encoder and the generative model are trained by one or more other processors included in a second computing entity.

Example 26. The one or more non-transitory computer-readable storage media of example 19, wherein the instructions further cause the one or more processors to train the machine learning encoder and the generative model.

Example 27. The one or more non-transitory computer-readable storage media of example 26, wherein the one or more processors are included in a first computing entity; and the machine learning encoder and the generative model are trained by one or more other processors included in a second computing entity.

What is claimed is:

1. A computer-implemented method comprising:
generating, by one or more processors and a machine learning encoder, a text segment vector using a text segment from a file;
determining, by the one or more processors, a subset of searching codes from a set of codes based on determining a distance between the text segment vector and a first code vector associated with a first searching code of the subset of searching codes;
generating, by the one or more processors, a generative model prompt based on the subset of searching codes; and
generating, by the one or more processors and a generative model, a code prediction for the text segment based on the generative model prompt.

2. The computer-implemented method of claim 1, wherein:
(i) a set of code vectors is previously generated for the set of codes using the machine learning encoder,
(ii) the first code vector is generated by the machine learning encoder based on the first searching code, and
(iii) the first searching code is a first code of the set of codes.

3. The computer-implemented method of claim 1, further comprising storing the code prediction in a lookup table in association with the text segment as a first code-text pair.

4. The computer-implemented method of claim 3, further comprising:
receiving a code update message identifying (a) one or more code modifications to one or more codes of the set of codes or (b) one or more additional codes to the set of codes; and
in response to the code update message, at least one of:
removing one or more code-text pairs from the lookup table that respectively correspond to the one or more codes indicated by the one or more code modifications;
generating, by the machine learning encoder, one or more additional code vectors using the one or more additional codes; or
storing the one or more additional codes in a vector data store in association with the one or more additional code vectors.

5. The computer-implemented method of claim 3, further comprising:
receiving a code request that identifies at least one of the file or the text segment from among at least one of structural text or at least another text segment in the file;
requesting an associated code from the lookup table based on the text segment and receiving the code request;
receiving a null response responsive to requesting the associated code; and
in response to the null response, generating the text segment vector.

6. The computer-implemented method of claim 5, further comprising:
determining that the file does not contain natural language text;
determining a conversion component associated with a file type associated with the file; and
detecting the text segment from the file based on processing the file using the conversion component.

7. The computer-implemented method of claim 1, wherein generating the generative model prompt based on the subset of searching codes comprises:
receiving a prompt template, and
modifying the prompt template to indicate the subset of searching codes.

8. The computer-implemented method of claim 7, wherein the prompt template comprises a few-shot prompt and the generative model comprises a question answering (Q/A) large language model (LLM).

9. The computer-implemented method of claim 1, wherein the number of codes within the subset of searching codes is determined based on a tunable code threshold.

10. A system comprising:
one or more processors; and
at least one memory storing processor-executable instructions that, when executed by the one or more processors, cause the one or more processors to perform operations comprising:
generating, using a machine learning encoder, a text segment vector using a text segment;
determining a subset of searching codes from a set of codes based on determining a distance between the text segment vector and a first code vector associated with a first searching code of the subset of searching codes;
generating a generative model prompt based on the subset of searching codes; and
generating, using a generative model, a code prediction for the text segment based on the generative model prompt.

11. The system of claim 10, wherein the text segment is extracted from a natural language document.

12. The system of claim 10, wherein:
(i) a set of code vectors is previously generated for the set of codes using the machine learning encoder,
(ii) the first code vector is generated by the machine learning encoder based on the first searching code, and
(iii) the first searching code is a first code of the set of codes.

13. The system of claim 10, wherein the operations further comprise storing the code prediction in a lookup table in association with the text segment as a first code-text pair.

14. The system of claim 13, wherein the operations further comprise:
receiving a code update message identifying (a) one or more code modifications to one or more codes of the set of codes or (b) one or more additional codes to the set of codes; and
in response to the code update message, at least one of:
removing one or more code-text pairs from the lookup table that respectively correspond to the one or more codes indicated by the one or more code modifications;
generating, by the machine learning encoder, one or more additional code vectors using the one or more additional codes; or
storing the one or more additional codes in a vector data store in association with the one or more additional code vectors.

15. The system of claim 13, wherein the operations further comprise:
receiving a code request that identifies at least one of a file or the text segment from among at least one of structural text or at least another text segment in the file;
requesting an associated code from the lookup table based on the text segment and receiving the code request;
receiving a null response responsive to requesting the associated code; and
in response to the null response, generating the text segment vector.

16. The system of claim 15, wherein the operations further comprise:
determining that the file does not contain natural language text;
determining a conversion component associated with a file type associated with the file; and
detecting the text segment from the file based on processing the file using the conversion component.

17. The system of claim 10, wherein to generate the generative model prompt based on the subset of searching codes the operations further comprise:
receiving a prompt template, and
modifying the prompt template to indicate the subset of searching codes.

18. The system of claim 17, wherein the prompt template comprises a few shot prompt and the generative model comprises a Q/A LLM.

19. One or more non-transitory computer-readable storage media storing instructions that, when executed by one or more processors, cause the one or more processors to perform operations comprising:
generating, using a machine learning encoder, a text segment vector using a text segment;
determining a subset of searching codes from a set of codes based on determining a distance between the text segment vector and a first code vector associated with a first searching code of the subset of searching codes;
generating a generative model prompt based on the subset of searching codes; and
generating, using a generative model, a code prediction for the text segment based on the generative model prompt.

20. The one or more non-transitory computer-readable storage media of claim 19, wherein the text segment is extracted from a natural language document.
